(19) United States
(12) Patent Application Publication
(10) Pub. No.: US 2015/0040112 A1
(43) Pub. Date: Feb. 5, 2015

(54) Enabling Interoperability Between Software Applications By Utilizing Partial Binaries

(71) Applicant: QUALCOMM Incorporated, San Diego, CA (US)

(72) Inventor: Andres Valencia, San Jose, CA (US)

(73) Assignee: QUALCOMM Incorporated, San Diego, CA (US)

(21) Appl. No.: 13/956,489

(22) Filed: Aug. 1, 2013

(51) Int. Cl. G06F 9/445

(52) U.S. Cl. CPC G06F 8/65
USPC 717/168

(57) ABSTRACT

Methods, devices, and systems for creating interoperability between applications that are not designed to be compatible by modifying a binary (or library binary) to encompass necessary functionality without an in-depth understanding of the additional content. A computing device may be configured to identify a function associated with a first binary that is missing from a second binary. In an aspect, the computing device may utilize error codes or diagnostic information from a loader/linker software. The computing device may analyze the first binary to identify a portion of code (or object) corresponding to the missing function, such as by evaluating related assembly code to identify a position-independent portion. The computing device may insert the identified portion of code into the second binary to generate a new binary. In an aspect, the computing device may utilize a dynamic linker configured to link to functions from both the first and second binaries.

### BACKGROUND

Modern smartphones (referred to as mobile devices) are especially powerful computing devices that utilize compiled code and data to perform various functions. Such compiled code and data are in the form of binaries that are loaded (or installed) onto the mobile device hardware, such as within internal memory for access by a processing unit. Binary code may include operating systems, bootstraps, functionality suites, executables, libraries, programs, and other processes needed by the mobile device to operate in its most essential capacities. Typically, the manufacturers of mobile devices (e.g., original equipment manufacturers or ‘OEMs’) install static binaries onto mobile devices that may be infrequently adjusted over time, such as by firmware updates.

Due to the essential nature of binaries to the operating of a mobile device, various entities may be interested in manipulating binaries to adjust the functionality set of the mobile device. For example, a third-party developer may wish to develop new features or upgrades to pre-existing binaries (e.g., virtual machine upgrades) and test them on end-user mobile devices to offer OEMs additional and vetted technologies (e.g., patches, new function suites, etc.). Further, parties may desire to adjust/access binaries to reverse engineer the binaries and promote new interoperability modifications (or mods). For example, modders may desire to jailbreak/root mobile operating systems to permit greater liberty in developing installed applications on smartphones. However, changing binaries will result in system failures if not implemented properly, as developers may inadvertently modify, remove, or otherwise disable essential functions established by OEMs. Although some modifications may be accomplished by copying the entire original content (or binaries), such solutions may include portions of the original binaries that aren't needed or that may not be selectively altered/customized/improved.

### SUMMARY

In an aspect, a computing device may perform a method to modify compiled binaries to achieve interoperability, and the method may include identifying a function associated with a first library binary that is missing within a second library binary without decompiling the first library binary, analyzing the first library binary to identify a portion of code corresponding to the missing function without decompiling the first library binary, inserting the identified portion of code corresponding to the missing function into a code associated with the second library binary, and generating a new library binary based on the code associated with the second library binary with the inserted portion of code. In an aspect, the portion of code may be one of an assembly code, binary code, and a data object. In an aspect, the missing function may be one of a method, routine, function, program, and application. In an aspect, identifying a function associated with a first library binary that is missing within a second library binary without decompiling the first library binary may include accessing the second library binary and obtaining diagnostic information from at least one of a linker software or a loader software. In an aspect, diagnostic information may include at least an error message. In an aspect, generating a new library binary based on the code associated with the second library binary with the inserted portion of code may include compiling a source code of the second library binary with a portion of a source code of the first library binary to generate the new library binary. In an aspect, the method may further include replacing the first library binary with the new library binary in a mobile device. In an aspect, the method may further include determining whether the identified portion of code corresponding to the missing function is position-independent, and generating a modification to the identified portion to remove dependencies on the first library binary, wherein the modification includes creating at least one of a new variable, a new pointer, and a new function. In an aspect, inserting the identified portion of code corresponding to the missing function into a code associated with the second library binary may include configuring a specialized linker to use both the second library binary and the identified portion within the first library binary corresponding to the missing function, and generating a new library binary may include installing both the first library binary and the second library binary. In an aspect, analyzing the first library binary to identify a portion of code corresponding to the missing function without decompiling the first library binary may be dynamically performed when the second library binary is implemented.

In another aspect, a computing device may be configured to modify compiled binaries to achieve interoperability and may include means for identifying a function associated with a first library binary that is missing within a second library binary without decompiling the first library binary, means for analyzing the first library binary to identify a portion of code corresponding to the missing function without decompiling the first library binary, means for inserting the identified portion of code corresponding to the missing function into a code associated with the second library binary, and means for generating a new library binary based on the code associated with the second library binary with the inserted portion of code. In an aspect, the portion of code may be one of an assembly code, binary code, and a data object. In an aspect, the missing function may be one of a method, routine, function, program, and application. In an aspect, means for identifying a function associated with a first library binary that is missing within a second library binary without decompiling the first library binary may include means for accessing the second library binary and obtaining diagnostic information from at least one of a linker software or a loader software. In an aspect, diagnostic information may include at least an error message. In an aspect, means for generating a new library binary based on the code associated with the second library binary with the inserted portion of code may include means for compiling a source code of the second library binary with a portion of a source code of the first library binary to generate the new library binary. In an aspect, the computing device may further include means for replacing the first library binary with the new library binary in a mobile device. In an aspect, the computing device may further include means for determining whether the identified portion of code corresponding to the missing function is position-independent, and means for generating a modification to the identified portion to remove dependencies on the first library binary, wherein the modification includes creating at least one of a new variable, a new pointer, and a new function. In an aspect, means for inserting the identified portion of code corresponding to the missing function into a code associated with the second library binary may include means for configuring a specialized linker to use both the second library binary and the identified portion within the first library binary corresponding to the missing function, and means for generating a new library binary may include means for installing both the first library binary and the second library binary. In an aspect, means for analyzing the first library binary to identify a portion of code corresponding to the missing function without decompiling the first library binary may be dynamically performed when the second library binary is implemented.

In another aspect, a computing device configured to modify compiled binaries to achieve interoperability may include a memory and a processor coupled to the memory, wherein the processor may be configured with processor-executable instructions to perform operations including identifying a function associated with a first library binary that is missing within a second library binary without decompiling the first library binary, analyzing the first library binary to identify a portion of code corresponding to the missing function without decompiling the first library binary, inserting the identified portion of code corresponding to the missing function into a code associated with the second library binary, and generating a new library binary based on the code associated with the second library binary with the inserted portion of code. In an aspect, the portion of code may be one of an assembly code, binary code, and a data object. In an aspect, the missing function may be one of a method, routine, function, program, and application. In an aspect, the processor may be configured with processor-executable instructions to perform operations such that identifying a function associated with a first library binary that is missing within a second library binary without decompiling the first library binary may include accessing the second library binary and obtaining diagnostic information from at least one of a linker software or a loader software. In an aspect, diagnostic information includes at least an error message. In an aspect, the processor may be configured with processor-executable instructions to perform operations such that generating a new library binary based on the code associated with the second library binary with the inserted portion of code may include compiling a source code of the second library binary with a portion of a source code of the first library binary to generate the new library binary. In an aspect, the processor may be configured with processor-executable instructions to perform operations further comprising replacing the first library binary with the new library binary in a mobile device. In an aspect, the processor may be configured with processor-executable instructions to perform operations that further include determining whether the identified portion of code corresponding to the missing function is position-independent, and generating a modification to the identified portion to remove dependencies on the first library binary, wherein the modification includes creating at least one of a new variable, a new pointer, and a new function. In an aspect, the processor may be configured with processor-executable instructions to perform operations such that inserting the identified portion of code corresponding to the missing function into a code associated with the second library binary may include configuring a specialized linker to use both the second library binary and the identified portion within the first library binary corresponding to the missing function, and the processor may be configured with processor-executable instructions to perform operations such that generating a new library binary may include installing both the first library binary and the second library binary. In an aspect, the processor may be configured with processor-executable instructions to perform operations such that analyzing the first library binary to identify a portion of code corresponding to the missing function without decompiling the first library binary may be dynamically performed when the second library binary is implemented.

In another aspect, a non-transitory processor-readable storage medium may have stored thereon processor-executable software instructions configured to cause a processor to perform operations for a computing device to modify compiled binaries to achieve interoperability including identifying a function associated with a first library binary that is missing within a second library binary without decompiling the first library binary, analyzing the first library binary to identify a portion of code corresponding to the missing function without decompiling the first library binary, inserting the identified portion of code corresponding to the missing function into a code associated with the second library binary, and generating a new library binary based on the code associated with the second library binary with the inserted portion of code. In an aspect, the portion of code may be one of an assembly code, binary code, and a data object. In an aspect, the missing function may be one of a method, routine, function, program, and application. In an aspect, the stored processor-executable software instructions may be configured to cause the processor to perform operations such that identifying a function associated with a first library binary that is missing within a second library binary without decompiling the first library binary may include accessing the second library binary and obtaining diagnostic information from at least one of a linker software or a loader software. In an aspect, diagnostic information includes at least an error message. In an aspect, the stored processor-executable software instructions may be configured to cause the processor to perform operations such that generating a new library binary based on the code associated with the second library binary with the inserted portion of code may include compiling a source code of the second library binary with a portion of a source code of the first library binary to generate the new library binary. In an aspect, the stored processor-executable software instructions may be configured to cause the processor to perform operations further comprising replacing the first library binary with the new library binary in a mobile device. In an aspect, the stored processor-executable software instructions may be configured to cause the processor to perform operations further including determining whether the identified portion of code corresponding to the missing function is position-independent, and generating a modification to the identified portion to remove dependencies on the first library binary, wherein the modification includes creating at least one of a new variable, a new pointer, and a new function. In an aspect, the stored processor-executable software instructions may be configured to cause the processor to perform operations such that inserting the identified portion of code corresponding to the missing function into a code associated with the second library binary may include configuring a specialized linker to use both the second library binary and the identified portion within the first library binary corresponding to the missing function, and the stored processor-executable software instructions may be configured to cause the processor to perform operations such that generating a new library binary may include installing both the first library binary and the second library binary. In an aspect, the stored processor-executable software instructions may be configured to cause the processor to perform operations such that analyzing the first library binary to identify a portion of code corresponding to the missing function without decompiling the first library binary may be dynamically performed when the second library binary is implemented.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a communication system block diagram of a communication network suitable for use with an aspect.

FIGS. 2A-2C are illustrations of example scenarios in which a mobile computing device utilizes various binaries.

FIG. 3A is a process flow diagram of an aspect method for inserting functions from a first binary into a second binary to generate a new binary and achieve interoperability.

FIG. 3B is a process flow diagram of another aspect method for inserting functions from a first binary into a second binary to generate a new binary and achieve interoperability.

FIG. 4 is a process flow diagram of another aspect method for inserting functions from a first binary into a second binary to generate a new binary and achieve interoperability.

FIG. 5 is a process flow diagram of another aspect method for inserting functions from a first binary into a second binary to generate a new binary and achieve interoperability.

FIG. 6 is a process flow diagram of an aspect method for dynamically inserting functions from a first library binary into a second library binary to achieve interoperability.

FIG. 7 is a process flow diagram of an aspect method for selectively using functions from a first library binary when the functions are missing from a second library binary to achieve interoperability.

FIG. 8 is a component block diagram of a mobile computing device suitable for use in an aspect.

FIG. 9 is a component block diagram of a server computing device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile computing device” or “computing device” are used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with at least a processor.

The various aspects include methods of combining functionalities of software binaries to enable interoperability between binaries or applications not originally designed to operate with each other. In other words, the aspect methods may be performed to create new binaries that function or fit in different systems. The methods may enable the modification of a compiled binary (e.g., an application, a library, etc.) using portions of binary code from an original binary, such as by swapping out or adding in original binary code. Aspect methods may not integrate complete source code and libraries followed by compiling the combination, and thus may not require a thorough understanding of the original binary code. For example, an aspect method may be performed to insert a portion of “as is” binary code from the original library into a new library without accessing the entire source code of the original binary. The aspect methods may be implemented in a computing device in an automatic or near automatic process.

In an aspect, a computing device may store or otherwise access both a first and a second binary, such as two binary files compiled from different libraries of applications/functions. For example, the first binary file may include the original library of operating functions as provided by an OEM and the second binary file may be a new, custom library of operating functions subsequently generated by a third-party. The computing device may perform operations to identify necessary portions, segments, data, variables, blocks, functions, or other information included in the first binary but missing from the second binary (or the library of the second binary). For example, the computing device may perform an emulation program using both binaries to detect errors describing missing components/functions. As another example, the computing device may execute functions of the second binary (e.g., boot-up or load the second library binary) to obtain load/link errors or codes associated with missing and expected library functions. In an aspect, the computing device may obtain diagnostic information from linker software and/or loader software, such as an error message. However, the various aspects are not to debug code, but instead to automatically (or near automatically) create new binaries based on missing functionality.

In an aspect, the computing device may be configured to analyze the first binary to identify a position-independent portion (or self-contained portion) of the first binary associated with identified missing functions. For example, the computing device may identify a block of code in the first binary that does not reference, point to, or otherwise link to other variables, data, or information within other portions of the first binary. In an aspect, the computing device may be configured to use analytical processes, routines, and/or applications to analyze the assembly code of the first binary to identify relevant code segments. For example, the computing device may utilize a source code analyzer or software used for analyzing bugs/security that identifies functional blocks within binaries, such as embedded application binary interfaces. In various aspects, binaries may be analyzed statically or dynamically. In another aspect, the computing device may also be configured to utilize non-position-independent portions of the first binary associated with identified missing functions. For example, the computing device may be configured to generate new variables in target source code and/or utilizing specialized linkers based on the second and first binaries. In other words, non-position-independent portions of a first binary may be modified to be position-independent for use with the second binary.

Once the first binary is analyzed and the code associated with the missing functions is identified, the computing device may insert that code into the second binary (or a new binary in place of the missing code) in order to generate a new binary. The computing device may insert data statically at compile time of the new binary. In various aspects, the computing device may not insert data (e.g., binary of missing functions) based on predefined sections or patch-points within the second binary. In another aspect, the computing device may copy assembly code from the first binary into a codebase (or source code) associated with the second binary and compile it to create the new binary. Such copied assembly code may or may not be decompiled from a binary. In another aspect, the computing device may copy a binary data object from the first binary into the second binary (or binary code) in order to generate the new binary. Using aspect techniques, the computing device may bypass a dynamic linker, and instead may utilize a static linking process that incorporates the new binary. In other words, libraries associated with the first binary may be replaced, overwritten, revised, or supplemented in favor of the new binary, which now includes the functions identified as missing from the second binary.

In general, the various aspects are unlike normal linking techniques in that otherwise unsupported (or unknown) functions may be added to a binary based on analysis and selective copying of portions of other original binaries. Additionally, the various aspects may or may not utilize any decompiling operations when adding missing functionality to a binary.

In alternative aspects, the computing device may be configured to identify missing functions by dynamically scanning source binaries and libraries. For example, the computing device may be configured to perform operations to dynamically identify entry points in dynamically-loaded libraries (DLLs) as well as extract associated pieces of code for insertion in new libraries or code. In another aspect, the computing device may be configured to load both the first binary and the second binary and execute methods from either as appropriate. For example, the computing device may utilize a custom or specialized linker that links to two DLLs and selects functions from either, such as based on overloaded entries for particular functions.

In various aspects, the new binary may be installed or loaded into various devices for execution. The computing device may be configured to use the new binary, or alternatively, may perform operations to transmit and/or install the new binary to a mobile device. For example, the computing device that generated the new binary may transmit the new binary to a smartphone for installation within a manufacturing facility. The various aspect methods and resulting binaries may be utilized by any one or more computing devices in various combinations.

The various aspects may be applicable to and utilize various types of binaries. Thus, the term “library binary” is used herein for convenience and should be not be construed to limit the aspects to any particular format, content, application, and/or use of any binary code, executables, binary files, and/or other compiled data.

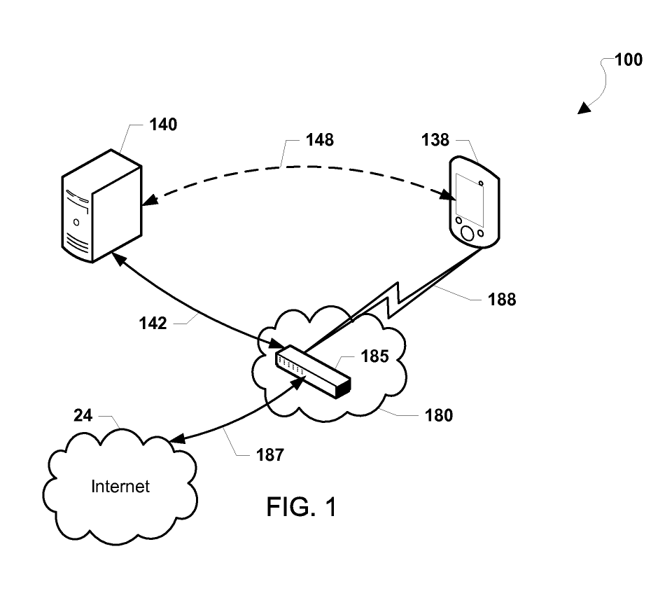

FIG. 1 illustrates a communication network 100 suitable for the various aspects. The communication network 100 may include various computing devices, such as a server computing device 140 and a mobile computing device 138. For example, the mobile computing device 138 may be a smartphone, such as an Android® or iPhone®, and the server computing device 140 may be a desktop computer, server blade, or a typical commercial server device. As described above, the mobile computing device 138 and/or the server computing device 140 may be configured to utilize various binaries, such as binaries of operating system images or library binaries (e.g., DLLs). In other words, the devices 138, 140 may be configured to perform various software, applications, routines, and operations for processing, analyzing, and accessing binaries.

In an aspect, the devices 140, 138 may be configured to exchange signals via a direct data links 148. For example, the mobile computing device 138 may be connected to the server computing device 140 via a wired data link 148 (e.g., a serial connection, parallel connection, direct cable connection, USB cable, etc.) or a short-range wireless data link 148 (e.g., Bluetooth, Bluetooth LE, WiFi Direct, infrared, RF, Zigbee, Peanut, etc.). Using the direct data links 148, the server computing device 140 may exchange binaries, software, and instructions with the mobile computing device 138, such as commands for installing a modified binary corresponding to a mobile operating system (e.g., Android).

The devices 140, 138 may be configured to transmit signals to a router device 185 via a wireless data links 188 or wired data links 142. For example, the devices 140, 138 may be connected to or otherwise in communication with the router device 185 within a developer facility, manufacturing building, or other installation. In an aspect, the server computing device 140 and the mobile computing device 138 may be configured to exchange binaries (e.g., modified library binary files, etc.) via a local area network 180 associated with the router device 185. In another aspect, the mobile computing device 138 may transmit the wireless signals via the wireless data link 188 by utilizing an embedded WiFi transceiver/radio.

In an aspect, the router device 185 may provide a connection 187 to the Internet 24, thus enabling the devices 140, 138 to communicate with other devices over the Internet 24. For example, the server computing device 140 may utilize the wired data link 142 to exchange data with a remote data source, such as an applications server (not shown) that distributes mods, library files, or other binaries. In another aspect, the mobile computing device 138 may also be configured to utilize a long-range radio or wireless transceiver to exchange data with a cellular tower (not shown) via a long-range data link (not shown). For example, a smartphone mobile computing device 138 may be equipped with a cellular network modem and an antenna capable of receiving binaries and other data transmissions via a 3G, 4G or LTE cellular network.

In an aspect, the server computing device 140 and/or the mobile computing device 138 may be configured to execute a disassembler program (e.g., an interactive disassembler application, etc.) that may access, modify, and otherwise analyze binary code and/or machine code as assembly code. For example, the server computing device 140 may be configured to execute a disassembler program that identifies functional blocks of assembly language code and/or call flows based on an analysis of a binary file.

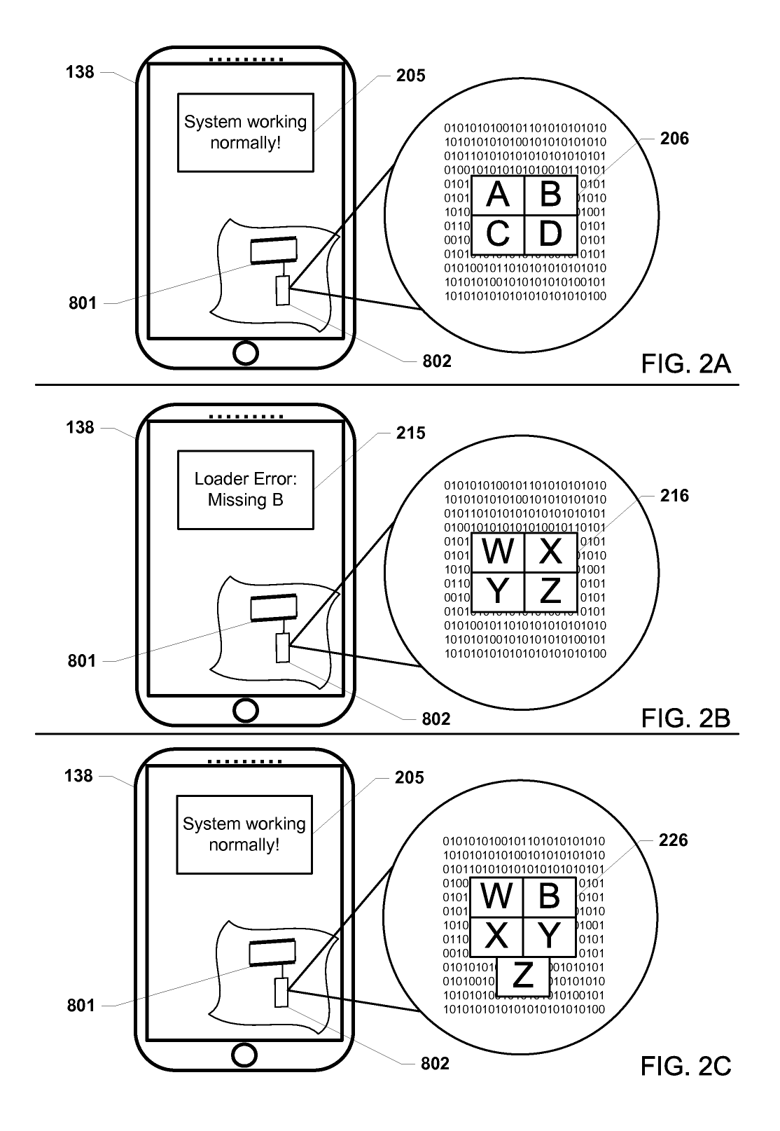

FIGS. 2A-2C illustrate example scenarios in which a mobile computing device 138 utilizes various binaries. FIG. 2A illustrates a first scenario in which the mobile computing device 138 is utilizing a first binary file stored in internal memory 802 that is connected to and accessible by a processor 801. In this example the first binary file is an unmodified or original binary file. For example, the first binary file may include machine code corresponding to a mobile operating system as developed and installed by an OEM. For illustration purposes, the first binary file includes a first set of functions 206 (e.g., functions ‘A,’ ‘B,’ ‘C,’ and ‘D’). For example, the first set of functions 206 may be functions developed by an OEM to enable the mobile computing device 138 to perform short-range signal processing (e.g., function ‘B’ may enable Bluetooth LE signal receipt and handling, etc.). In various aspects, the mobile computing device 138 may be configured to perform loader and/or linker software that accesses, evaluates, and utilizes binaries. Such software may cause the mobile computing device 138 to display various information on the device's output units (e.g., LCD touchscreen display). For example, in response to an error-free load of the first binary, the mobile computing device 138 may render a message 205 that indicates that the system is working normally.

FIG. 2B illustrates a second scenario in which the mobile computing device 138 is utilizing a second binary file stored in internal memory 802 that is a modified binary file, such as including machine code of a modified mobile operating system developed by a third-party (e.g., a modder) that is different from a system developed and installed by an OEM. In this example, the second binary file is illustrated as including a second set of functions 216 (e.g., functions ‘W,’ ‘X,’ ‘Y,’ and ‘Z’) developed by the third-party developer that were not included in an original operating system binary installed on a smartphone by an OEM. In this example scenario, the second binary is missing important content, such as functions or libraries originally installed on the mobile computing device 138 by the OEM. Without this content, the mobile computing device 138 will not be fully operable and generates errors. Based on the loader/linker software diagnostics (e.g., errors, etc.) and operations, the mobile computing device 138 may render a message 215 that indicates the various functions of the second binary is missing (e.g., missing function ‘B’ from the first binary described in FIG. 2A).

FIG. 2C illustrates a third scenario in which the mobile computing device 138 is utilizing a third binary file stored in internal memory 802 that is a new binary file based on portions of the original binary file combined with another binary file. In this example, the third binary is a modification of the second binary file (e.g., the second binary referred to in FIG. 2B) generated after inserting content from an original binary file (e.g., the first binary referred to in FIG. 2A). In the example, the third binary file includes a third set of functions 226 (e.g., functions ‘W,’ ‘B,’ ‘X,’ ‘Y,’ and ‘Z’) that all functions of the second binary file (e.g., functions ‘W,’ ‘X,’ ‘Y,’ and ‘Z’), as well as a missing function from the first binary file that is needed to properly operate the mobile computing device 138 (e.g., function ‘B’). For example, the third binary may include all of the OEM-developed Bluetooth LE handling functions that are needed, requested, or otherwise utilized by a loader/linker software during boot-up operations of a smartphone. In the illustrated example, the mobile computing device 138 render a message 205 indicating that the various functions of the third binary enable the mobile computing device 138 to operate normally.

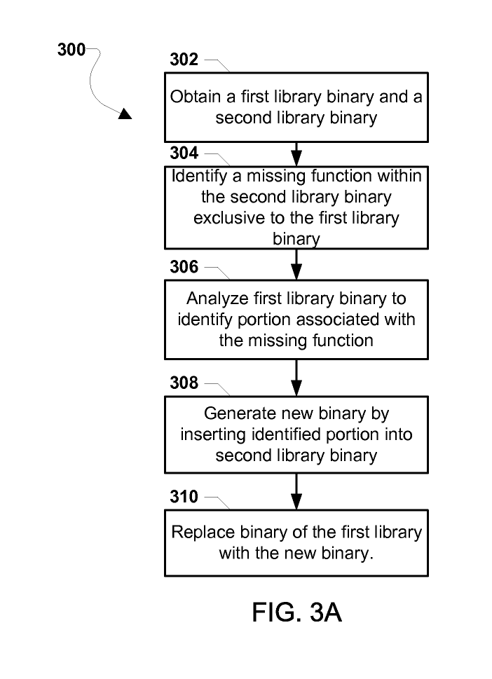

FIG. 3A illustrates an aspect method 300 for inserting functions from a first binary into a second binary to generate a new binary and achieve interoperability. Aspect method 300 may be implemented in a computing device as an automated process. As described above, binaries (or library binaries) may include various functions, operations, applications, and other information that may be required by a device in order to function properly. For example, certain routines performed by a mobile device's operating system may call, utilize, or reference functions within a library (e.g., dynamically loaded library or ‘DLL,’ etc.) associated with a particular library binary. When the functions are not accessible by the routines (e.g., the library binary was not loaded onto the mobile device), the mobile device may fail to boot, cease performing certain operations, or otherwise experience malfunctions that impair the device. The computing device may perform the method 300 to generate a new binary that combines the functions of a modified or custom library binary with the required, missing functions of an original library binary. In various aspects, the computing device may be a mobile computing device (e.g., a smartphone) configured to generate new binaries for its own use, or alternatively a device, such as the server computing device 140 described above, configured to generate new binaries for distribution/installation on separate devices.

In block 302, the computing device may obtain a first library binary and a second library binary. For example, the first library binary may be an original binary developed by an OEM for installation on a smartphone, and the second library binary may be a modified binary developed by a third-party developer (or “modder”) to improve the original binary and increase the capabilities of the smartphone. The binaries may be obtained by various techniques, such as by downloading via a network connection (e.g., from a modder website via the Internet, etc.), retrieving from a local storage location/device (e.g., from a hard drive or optical disc), and/or by transmission from a nearby computing device (e.g., via Bluetooth signaling from a proximate mobile device).

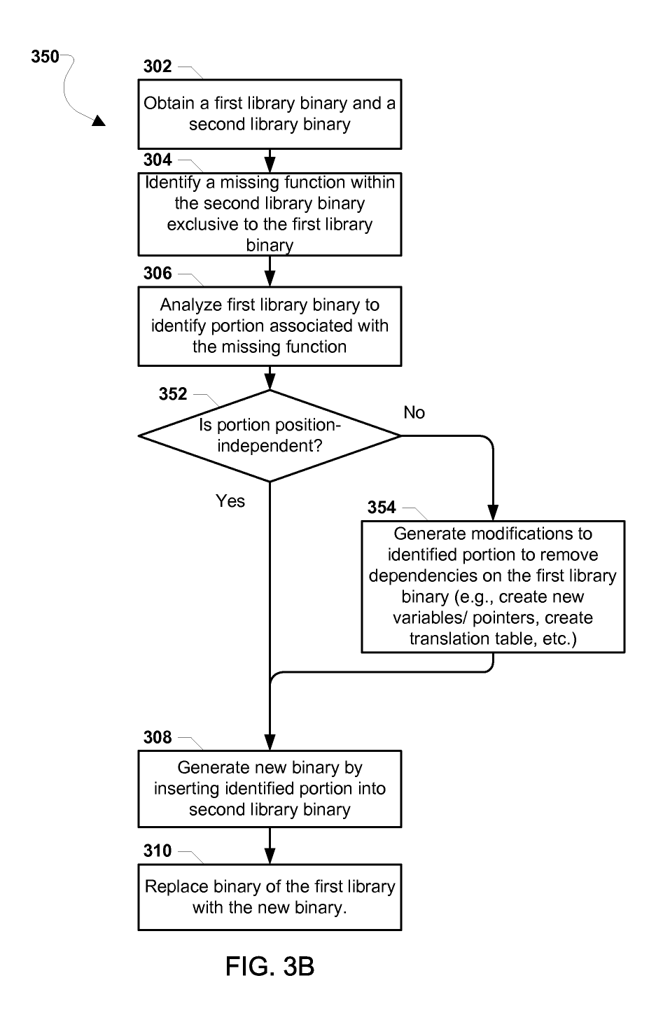

In block 304, the computing device may identify a missing function within the second library binary exclusive to the first library binary. In various aspects, the missing function may include a method, a routine, a function, a program, an application programming interface (API) and/or an application. The identification may be accomplished by the computing device by executing routines, software, and other operations that may utilize the second library binary file in a manner or context similar to how the first binary library binary may be used. For example, the computing device may run the second library binary to collect error codes indicating the types of errors encountered or generated with the second library binary is executed. An aspect method for this identification process is described below with reference to FIG. 4. In various aspects, the computing device may identify missing functions without decompiling the first library binary.

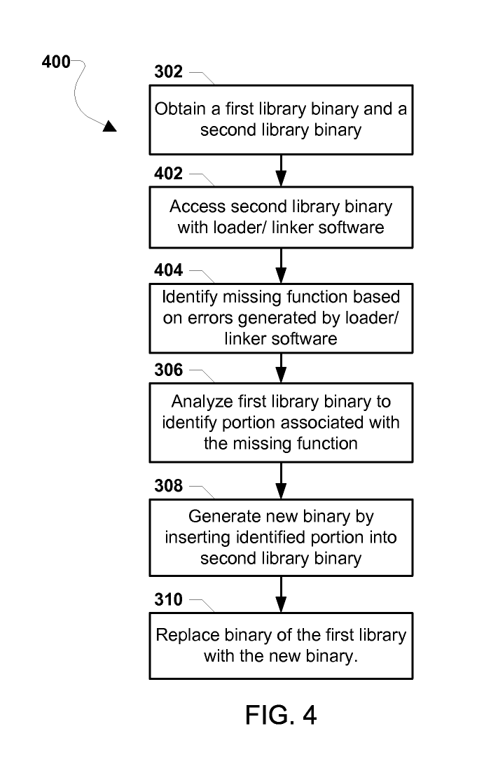

In block 306, the computing device may analyze the first library binary to identify a portion associated with the missing function. In other words, the computing device may identify the portion of the first library binary that includes the code, operations, data, and other information needed to perform the missing function. For example, the computing device may identify the contiguous section of machine code within the first library binary that corresponds to a position-independent function missing from the second library binary. An aspect method for performing this analysis is described below with reference to FIG. 5.

In block 308, the computing device may generate a new binary by inserting the identified portion into the second library binary. The new binary may be substantially similar to the second library binary, adding only the portion of the first library binary associated with the missing function. The computing device may not perform any conversion operations or procedures on the identified portion of the first library binary, but instead may directly copy information of the identified portion from the first library binary into the second library binary. For example, the computing device may copy a portion of assembly source code or an object file from the first library binary file into the second library function. Further, the computing device may not utilize any predefined insertion points within the second library binary for determining where to insert the identified portion of the first library binary. Operations for generating new binaries are discussed below.

In block 310, the computing device may replace the binary of the first library with the new binary. For example, the computing device may overwrite the first library binary with the new binary. In an aspect, the computing device may replace, install, or otherwise utilize the new binary for its own operations (e.g., installed for use by the computing device's operating system) or alternatively the computing device may install or cause the new binary to be installed on another device. For example, the computing device may transmit the new binary along with installation/replacement instructions to a mobile computing device via wired/wireless communications.

FIG. 3B illustrates an aspect method 350 for inserting functions from a first binary into a second binary to generate a new binary and achieve interoperability. Aspect method 350 may be implemented in a computing device as an automated process. The method 350 is similar to the method 300 described above, except that the method 350 may include additional operations for generating a new binary when missing functions that need to be represented in the new binary are non-position-independent. As described above, position-independent functions are those functional elements within a binary that are self-contained and thus may be easily extracted from the binary and inserted into another binary. For example, a position-independent function may be represented by a contiguous block of machine code within a binary. In other words, position-independent functions of an original binary may function properly without accessing, calling, referencing, or otherwise using any other portion, information, method, variable, code, or data from the original binary. Alternatively, non-position-independent functions may require other elements of a binary in order to produce their desired effects, math, data transformations, calculations, and/or routines. Because of this inter-related nature, the computing device may perform more operations to determine the connections or dependencies that non-position-independent functions may have to an original binary. Once such connections or dependencies are determined, the computing device may remove or modify the connections/dependencies to enable the porting of the functions into other binaries. For example, when the computing device identifies a first function within a first binary to be inserted into a second binary and that first function points to a variable in a block of code associated with a second function within the first binary, the computing device may generate new code to duplicate that variable without copying the block of code associated with the second function.

In block 302, the computing device may obtain a first library binary and a second library binary. In block 304, the computing device may identify a missing function within the second library binary exclusive to the first library binary. In block 306, the computing device may analyze the first library binary to identify a portion associated with the missing function. In determination block 352, the computing device may determine whether the identified portion is position-independent. In other words, based on the analysis of the first library binary, the computing device may be configured to determine whether the identified portion is connected to, references, calls, points to, or otherwise is reliant upon any other portion, variable, code, or information of the first library binary. For example, the identified portion may not be position-independent when the computing device determines the portion includes a pointer to a variable managed within a separate block of code in the first library binary. In an aspect, the computing device may make this determination by evaluating information related to linker processes or software, or alternatively may perform mapping operations to identify any connectivity or dependencies within the first library binary.

If the portion is not position-independent (i.e., determination block 352=“No”), in block 354, the computing device may generate modifications to the identified portion to remove dependencies on the first library binary. In an aspect, the modifications may include creating a new variable and/or creating a new pointer to avoid reliance on functions, data, or other information included within other portions of the first library binary. For example, the computing device may be configured to generate new code added to the identified portion that represents variables, functions, pointers, and other operations represented within other portions of the first library binary. In an aspect, the computing device may utilize a translation table to generate modifications that remove dependencies.

If the portion is position-independent (i.e., determination block 352=“Yes”), or if the operations in block 354 have been executed, in block 308, the computing device may generate a new binary by inserting the identified portion into the second library binary. In block 310, the computing device may replace the binary of the first library with the new binary.

FIG. 4 illustrates another aspect method 400 for a computing device to insert functions from a first binary into a second binary to generate a new binary and achieve interoperability. As indicated above, the computing device may be configured to identify capabilities, code, functions, methods, variables, and other information that must be present when executing operations related to the second binary. In other words, the computing device may perform operations to identify portions of the first binary that, when missing, may cause a device to malfunction.

In block 302, the computing device may obtain a first library binary and a second library binary. In block 402, the computing device may access the second library binary with a loader/linker software. In other words, the computing device may implement or activate the second library binary in a normal operating environment by loading the second library binary into memory. For example, the computing device may use routines, instructions, or software to load, install, or otherwise activate the second library binary for use in operating system routines executing on the computing device's processor. In various aspects, the computing device may utilize a dynamic linker software, unit, component, or routines. In other aspects, the computing device may access the second library binary using an emulation application, such as an application that replicates the operating conditions of certain hardware or operating systems relevant to the first library binary.

In block 404, the computing device may identify a missing function based on errors generated by the loader/linker software. In particular, when the second library binary is loaded, the computing device may be configured to log errors and other diagnostics information that indicates whether any functions are required, malfunctioning, and/or missing. For example, at load-time (or alternatively run-time), the computing device may encounter errors with unresolved symbols, variables, functions, or other information within the second library binary and may perform operations to record these errors as codes or other descriptions within a log file.

In block 306, the computing device may analyze the first library binary to identify a portion associated with the missing function. For example, the computing device may identify the portion of the first library binary that corresponds to the missing function indicated in a loader error log file stored within memory. In block 308, the computing device may generate a new binary by inserting the identified portion into the second library binary. In block 310, the computing device may replace the binary of the first library with the new binary.

FIG. 5 illustrates another aspect method 500 for a computing device to insert functions from a first binary into a second binary to generate a new binary and achieve interoperability. Third-party developers may not have access to the complete source code associated with the first binary. For example, modders of a mobile device operating system may not have the C++, Java, or other high-level language programming code that is compiled to create the operating system. So, to resolve issues and errors with missing functions, these third-parties may analyze and extract portions of information based on the binary (or binary code) that is available to them. As indicated above, the computing device may be configured to identify blocks of code, object files, and other information within the first library binary that correspond to missing functions, thereby enabling such developers to modify binaries of software without requiring the codebase originally compiled to generate the binaries.

In block 302, the computing device may obtain a first library binary and a second library binary. In block 304, the computing device may identify a missing function within the second library binary exclusive to the first library. In block 502, the computing device may obtain a first library source code associated with the first library binary. For example, the computing device may execute a disassembler application to generate source code, such as ARM assembly code, based on the first binary file. However, the computing device may or may not necessarily utilize a decompiler or decompiling process to obtain the first library source code. In block 504, the computing device may analyze the first library source code to identify a portion associated with the missing function. For example, the computing device may execute source analyzer applications, routines, or operations to compare the missing function with the various functions included within the source code representing the first library binary. In an aspect, the computing device may utilize an embedded application binary interface to perform the analysis.

In various aspects, the computing device may perform operations to test the accuracy of identified portions and ensure the completeness of functions included therein. For example, once the portion of the first library binary is identified, such as via a source code analyzer routine, the computing device may simulate the functionality of the portion with test data and detect whether errors are encountered, thus indicating whether the identified portion truly represents the missing function. In various aspects, such operations to test the identified portion may be similar to the operations described above with reference to determination block 352 in FIG. 3B. For example, the computing device may test the identified portion to determine whether the portion is position-independent and thus a complete representation of the missing function.

In block 506, the computing device may obtain the source code for the second library binary. In many cases, the computing device may be associated with the party that creates the second library binary. For example, the computing device may be a computer used by a developer of the second library binary. In such a case, the computing device may simply obtain the second library binary source code from a local storage location. In another aspect, the computing device may or may not perform operations similar to those described above with reference to block 502, such as obtaining source code based on decompiling the second library binary. In block 508, the computing device may insert the identified portion associated with the missing function into the second library source code. For example, the computing device may be configured to copy assembly code associated with the identified portion into the assembly code of the second library binary. The insertion may not be predefined by within the second library source code, such as a place for patching modified or new content (e.g., functions) defined by a developer. In block 510, the computing device may compile the second library source code with the inserted portion to generate a new binary, such as a new binary that includes the functions of the second library and the missing function from the first library. In block 310, the computing device may replace the binary of the first library with the new binary.

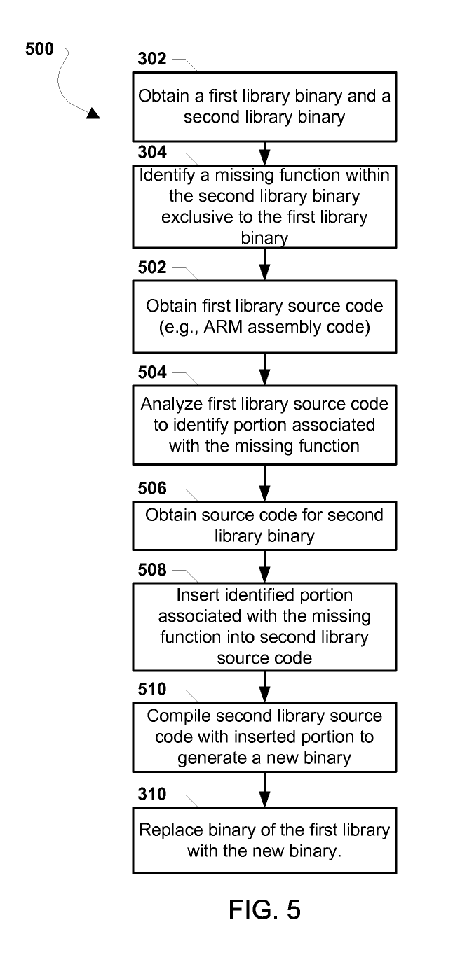

FIG. 6 illustrates an aspect method 600 for a computing device to dynamically insert functions from a first library binary into a second library binary to achieve interoperability. In the above descriptions, the various aspects may be considered static techniques for inserting missing functions into a second binary. For example, by performing the method 300, a computing device may statically create a new binary that includes missing functions from a first library binary and is based on a second library binary, where the new binary is first generated and then executed by the computing device (or another device) without using a dynamic linker. However, the computing device may also be configured to perform the method 600 described below to identify and insert binary code as the computing device utilizes the secondary library file (i.e., at runtime). In other words, the computing device may dynamically find and insert missing functions from the first binary when needed during the use of the second binary.

In block 302, the computing device may obtain a first library binary and a second library binary. In block 602, the computing device may implement the second library binary in place of the first library binary. In other words, when the first library binary is the default or typically loaded library, the second library binary may be loaded instead. In such a case, the first library binary may be accessible to the computing device, such as stored within volatile memory, but may not be linked to for the purposes of executing applications or routines. In block 604, the computing device may dynamically identify a function missing from the second library binary that is exclusive to the first library binary. Thus, as an application is executing on the processor of the computing device, the computing device may detect and report errors or other failures to perform the application due to unlinked (or non-existent) functions, routines, variables, data, and/or other information. In an aspect, the computing device may perform routines to catch or otherwise handle errors, interrupts, or other actions resulting from the missing function. For example, the computing device may employ an interrupt handler routine that listens for interrupts generated by a loader/linker and that freezes applications that are requesting missing functions not within the second library binary. In this way, the computing device may avoid failures or calamitous results in the event a missing function is invoked by applications or routines executing on the computing device.

In block 306, the computing device may analyze the first library binary to identify a portion associated with the missing function, as described above. In block 606, the computing device may dynamically insert the identified portion associated with the missing function into the second library binary, such as into a volatile memory address associated with the second library binary. The computing device may continue with the operations in block 604. In an aspect, the computing device may utilize a dynamic linker.

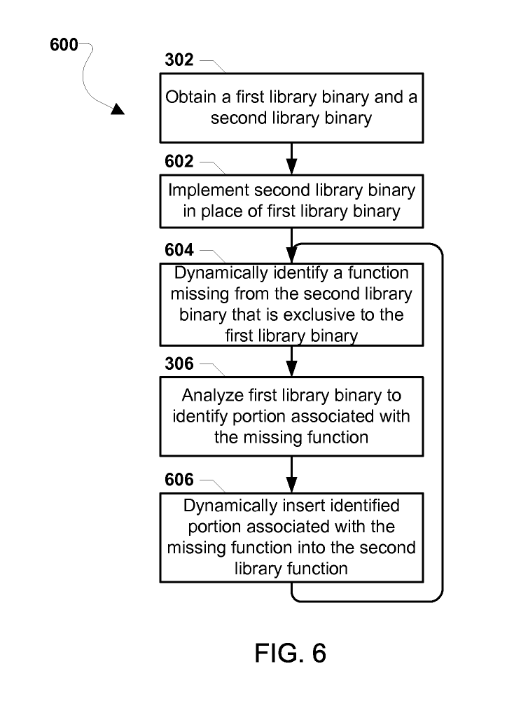

FIG. 7 illustrates an aspect method 700 for a computing device to selectively use functions from a first library binary when missing from a second library binary to achieve interoperability. Unlike the techniques discussed above, the method 700 may be performed by a computing device to access contents of both the first library binary and the second library binary during the execution of software/operations/routines that may utilize the content within the binaries. In other words, the computing device may not extract portions of the first library binary prior to executing operations/applications that utilize the first library binary, but instead may configure a specialized linker or loader to point to (or reference) content within both libraries.

In block 302, the computing device may obtain a first library binary and a second library binary. In block 304, the computing device may identify a missing function within the second library binary exclusive to the first library binary. In block 306, the computing device may analyze the first library binary to identity a portion associated with the missing function. In block 702, the computing device may install both the first and the second library binaries, such as by loading both the binaries into memory for use with applications or routines executing on the computing device's processor. In block 704, the computing device may configure a specialized loader/linker to use the second library binary and the identified portion of the first library binary corresponding to the missing function. In other words, the specialized linker may be adjusted by the computing device to include pointers, routines, and/or instructions that may cause the computing device to utilize the information of the second library binary except when there are references to the missing function, in which case the loader/linker may direct the computing device to utilize the identified portion of the first library binary.

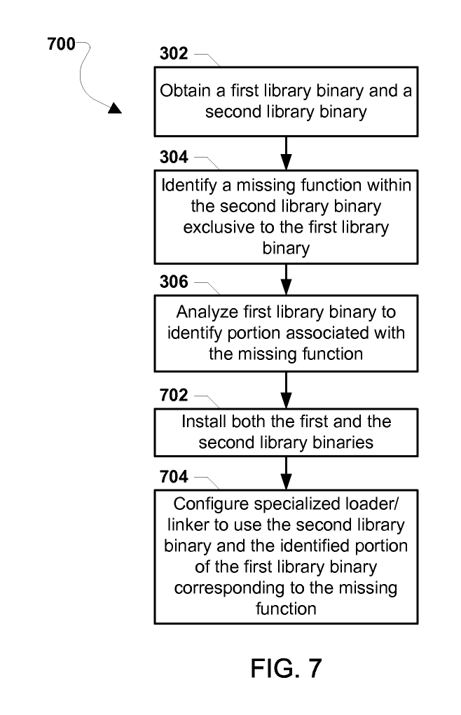

FIG. 8 is a system block diagram of a smartphone-type mobile computing device 138 suitable for use with various aspects. The smartphone mobile computing device 138 may include a processor 801 coupled to internal memory 802, a display 803, and to a speaker 854. Additionally, the smartphone mobile computing device 138 may include an antenna 804 for sending and receiving electromagnetic radiation that may be connected to a wireless data link and/or long-range wireless signal transceiver 805, such as a cellular network or WiFi radio, coupled to the processor 801 and capable of communicating over a wide area wireless communication network. Smartphone mobile computing devices 138 may include a separate short-range radio transceiver 824 capable of communicating or pairing with other mobile computing devices. Smartphone mobile computing devices 138 typically may also include menu selection buttons or rocker switches 808 for receiving user inputs. Additionally, the smartphone mobile computing device 138 may include an accelerometer 810, a gyroscope 811, and a GPS receiver chip 814 coupled to the processor 801. In an aspect, the smartphone mobile computing device 138 may also include a microphone 812 and a camera 813 coupled to the processor 801.

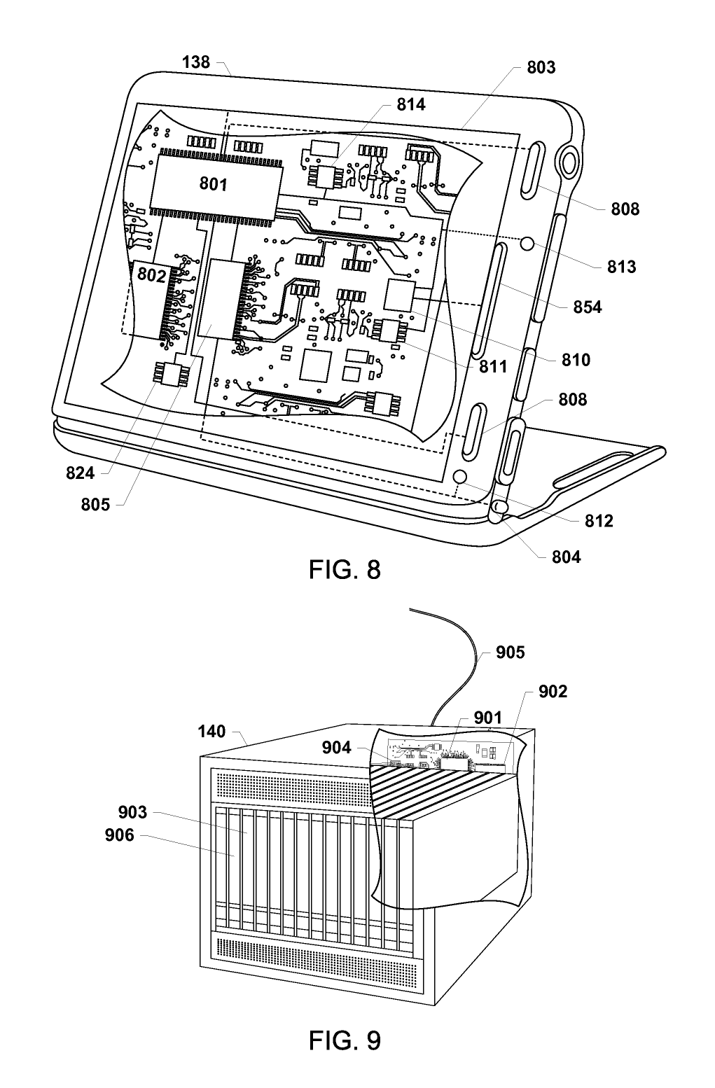

The various aspects may be implemented on any of a variety of commercially available server devices, such as the server computing device 140 illustrated in FIG. 9. Such a server computing device 140 typically includes a processor 901 coupled to volatile memory 902 and a large capacity nonvolatile memory, such as a disk drive 903. The server computing device 140 may also include a floppy disc drive, compact disc (CD) or DVD disc drive 906 coupled to the processor 901. The server computing device 140 may also include network access ports 904 coupled to the processor 901 for establishing data connections with a network 905, such as a local area network coupled to other broadcast system computers and servers.

The processors 801 and 901 may be any programmable microprocessor, microcomputer or multiple processor chip or chips that can be configured by software instructions (applications) to perform a variety of functions, including the functions of the various aspects described above. In the various devices, multiple processors may be provided, such as one processor dedicated to wireless communication functions and one processor dedicated to running other applications. Typically, software applications may be stored in the internal memory 802 and 902 before they are accessed and loaded into the processors 801 and 901. The processors 801 and 901 may include internal memory sufficient to store the application software instructions. In many devices the internal memory may be a volatile or nonvolatile memory, such as flash memory, or a mixture of both. For the purposes of this description, a general reference to memory refers to memory accessible by the processors 801 and 901 including internal memory or removable memory plugged into the various devices and memory within the processors 801 and 901.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module that may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium that may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for a computing device to modify compiled binaries to achieve interoperability, comprising:
identifying a function associated with a first library binary that is missing within a second library binary without decompiling the first library binary;
analyzing the first library binary to identify a portion of code corresponding to the missing function without decompiling the first library binary;
inserting the identified portion of code corresponding to the missing function into a code associated with the second library binary; and
generating a new library binary based on the code associated with the second library binary with the inserted portion of code.

2. The method of claim 1, wherein the portion of code is one of an assembly code, binary code, and a data object.

3. The method of claim 1, wherein the missing function is one of a method, routine, function, program, and application.

4. The method of claim 1, wherein identifying a function associated with a first library binary that is missing within a second library binary without decompiling the first library binary comprises accessing the second library binary and obtaining diagnostic information from at least one of a linker software or a loader software.

5. The method of claim 1, wherein diagnostic information includes at least an error message.

6. The method of claim 1, wherein generating a new library binary based on the code associated with the second library binary with the inserted portion of code comprises compiling a source code of the second library binary with a portion of a source code of the first library binary to generate the new library binary.

7. The method of claim 1, further comprising replacing the first library binary with the new library binary in a mobile device.

8. The method of claim 1, further comprising:
determining whether the identified portion of code corresponding to the missing function is position-independent; and
generating a modification to the identified portion to remove dependencies on the first library binary, wherein the modification includes creating at least one of a new variable, a new pointer, and a new function.

9. The method of claim 1, wherein inserting the identified portion of code corresponding to the missing function into a code associated with the second library binary comprises configuring a specialized linker to use both the second library binary and the identified portion within the first library binary corresponding to the missing function, and
wherein generating a new library binary comprises installing both the first library binary and the second library binary.

10. The method of claim 1, wherein analyzing the first library binary to identify a portion of code corresponding to the missing function without decompiling the first library binary is dynamically performed when the second library binary is implemented.

11. A computing device configured to modify compiled binaries to achieve interoperability, comprising:
means for identifying a function associated with a first library binary that is missing within a second library binary without decompiling the first library binary;
means for analyzing the first library binary to identify a portion of code corresponding to the missing function without decompiling the first library binary;
means for inserting the identified portion of code corresponding to the missing function into a code associated with the second library binary; and
means for generating a new library binary based on the code associated with the second library binary with the inserted portion of code.

12. The computing device of claim 11, wherein the portion of code is one of an assembly code, binary code, and a data object.

13. The computing device of claim 11, wherein the missing function is one of a method, routine, function, program, and application.

14. The computing device of claim 11, wherein means for identifying a function associated with a first library binary that is missing within a second library binary without decompiling the first library binary comprises means for accessing the second library binary and obtaining diagnostic information from at least one of a linker software or a loader software.

15. The computing device of claim 11, wherein diagnostic information includes at least an error message.

16. The computing device of claim 11, wherein means for generating a new library binary based on the code associated with the second library binary with the inserted portion of code comprises means for compiling a source code of the second library binary with a portion of a source code of the first library binary to generate the new library binary.

17. The computing device of claim 11, further comprising means for replacing the first library binary with the new library binary in a mobile device.

18. The computing device of claim 11, further comprising:
means for determining whether the identified portion of code corresponding to the missing function is position-independent; and
means for generating a modification to the identified portion to remove dependencies on the first library binary, wherein the modification includes creating at least one of a new variable, a new pointer, and a new function.

19. The computing device of claim 11, wherein means for inserting the identified portion of code corresponding to the missing function into a code associated with the second library binary comprises means for configuring a specialized linker to use both the second library binary and the identified portion within the first library binary corresponding to the missing function, and
wherein means for generating a new library binary comprises means for installing both the first library binary and the second library binary.

20. The computing device of claim 11, wherein means for analyzing the first library binary to identify a portion of code corresponding to the missing function without decompiling the first library binary is dynamically performed when the second library binary is implemented.

21. A computing device configured to modify compiled binaries to achieve interoperability, comprising:
a memory; and
a processor coupled to the memory and configured with processor-executable instructions to perform operations comprising:
identifying a function associated with a first library binary that is missing within a second library binary without decompiling the first library binary;
analyzing the first library binary to identify a portion of code corresponding to the missing function without decompiling the first library binary;
inserting the identified portion of code corresponding to the missing function into a code associated with the second library binary; and
generating a new library binary based on the code associated with the second library binary with the inserted portion of code.

22. The computing device of claim 21, wherein the portion of code is one of an assembly code, binary code, and a data object.

23. The computing device of claim 21, wherein the missing function is one of a method, routine, function, program, and application.

24. The computing device of claim 21, wherein the processor is configured with processor-executable instructions to perform operations such that identifying a function associated with a first library binary that is missing within a second library binary without decompiling the first library binary comprises accessing the second library binary and obtaining diagnostic information from at least one of a linker software or a loader software.

25. The computing device of claim 21, wherein diagnostic information includes at least an error message.

26. The computing device of claim 21, wherein the processor is configured with processor-executable instructions to perform operations such that generating a new library binary based on the code associated with the second library binary with the inserted portion of code comprises compiling a source code of the second library binary with a portion of a source code of the first library binary to generate the new library binary.

27. The computing device of claim 21, wherein the processor is configured with processor-executable instructions to perform operations further comprising replacing the first library binary with the new library binary in a mobile device.

28. The computing device of claim 21, wherein the processor is configured with processor-executable instructions to perform operations further comprising:
determining whether the identified portion of code corresponding to the missing function is position-independent; and
generating a modification to the identified portion to remove dependencies on the first library binary, wherein the modification includes creating at least one of a new variable, a new pointer, and a new function.

29. The computing device of claim 21, wherein the processor is configured with processor-executable instructions to perform operations such that inserting the identified portion of code corresponding to the missing function into a code associated with the second library binary comprises configuring a specialized linker to use both the second library binary and the identified portion within the first library binary corresponding to the missing function, and
wherein the processor is configured with processor-executable instructions to perform operations such that generating a new library binary comprises installing both the first library binary and the second library binary.

30. The computing device of claim 21, wherein the processor is configured with processor-executable instructions to perform operations such that analyzing the first library binary to identify a portion of code corresponding to the missing function without decompiling the first library binary is dynamically performed when the second library binary is implemented.

31. A non-transitory processor-readable storage medium having stored thereon processor-executable software instructions configured to cause a processor to perform operations for a computing device to modify compiled binaries to achieve interoperability, the operations comprising:
identifying a function associated with a first library binary that is missing within a second library binary without decompiling the first library binary;
analyzing the first library binary to identify a portion of code corresponding to the missing function without decompiling the first library binary;
inserting the identified portion of code corresponding to the missing function into a code associated with the second library binary; and
generating a new library binary based on the code associated with the second library binary with the inserted portion of code.

32. The non-transitory processor-readable storage medium of claim 31, wherein the portion of code is one of an assembly code, binary code, and a data object.

33. The non-transitory processor-readable storage medium of claim 31, wherein the missing function is one of a method, routine, function, program, and application.

34. The non-transitory processor-readable storage medium of claim 31, wherein the stored processor-executable software instructions are configured to cause the processor to perform operations such that identifying a function associated with a first library binary that is missing within a second library binary without decompiling the first library binary comprises accessing the second library binary and obtaining diagnostic information from at least one of a linker software or a loader software.

35. The non-transitory processor-readable storage medium of claim 31, wherein diagnostic information includes at least an error message.

36. The non-transitory processor-readable storage medium of claim 31, wherein the stored processor-executable software instructions are configured to cause the processor to perform operations such that generating a new library binary based on the code associated with the second library binary with the inserted portion of code comprises compiling a source code of the second library binary with a portion of a source code of the first library binary to generate the new library binary.

37. The non-transitory processor-readable storage medium of claim 31, wherein the stored processor-executable software instructions are configured to cause the processor to perform operations further comprising replacing the first library binary with the new library binary in a mobile device.

38. The non-transitory processor-readable storage medium of claim 31, wherein the stored processor-executable software instructions are configured to cause the processor to perform operations further comprising:
determining whether the identified portion of code corresponding to the missing function is position-independent; and
generating a modification to the identified portion to remove dependencies on the first library binary, wherein the modification includes creating at least one of a new variable, a new pointer, and a new function.

39. The non-transitory processor-readable storage medium of claim 31, wherein the stored processor-executable software instructions are configured to cause the processor to perform operations such that:
inserting the identified portion of code corresponding to the missing function into a code associated with the second library binary comprises configuring a specialized linker to use both the second library binary and the identified portion within the first library binary corresponding to the missing function, and
generating a new library binary comprises installing both the first library binary and the second library binary.

40. The non-transitory processor-readable storage medium of claim 31, wherein the stored processor-executable software instructions are configured to cause the processor to perform operations such that analyzing the first library binary to identify a portion of code corresponding to the missing function without decompiling the first library binary is dynamically performed when the second library binary is implemented.
